(19) United States
(12) Patent Application Publication
(10) Pub. No.: US 2024/0412716 A1
(43) Pub. Date: Dec. 12, 2024

(54) Electronic Trumpet Playable Without a Mouthpiece

(71) Applicants: Andrew Thomas Hauck, PALO ALTO, CA (US); Lane Thomas Hauck, SAN DIEGO, CA (US)

(72) Inventors: Andrew Thomas Hauck, PALO ALTO, CA (US); Lane Thomas Hauck, SAN DIEGO, CA (US)

(21) Appl. No.: 18/331,106

(22) Filed: Jun. 7, 2023

(51) Int. Cl. G10H 1/00; G10H 1/26

(52) U.S. Cl. CPC G10H 1/0008; G10H 1/0066; G10H 1/26; G10H 2210/161; G10H 2210/265; G10H 2220/521; G10H 2230/175; G10H 2240/285

(57) ABSTRACT

An electronic trumpet emulating the valves of a trumpet, playable without a mouthpiece. Electronic sensors detect valve positions and pushbuttons select note intervals and play notes when pressed. An internal microcontroller translates valve and button states into Musical Instrument Digital Instrument (MIDI) messages suitable for transmission to an external music synthesizer or internal MIDI Synthesizer Integrated Circuit.

### PRIOR ART

Electronic trumpets are known. Two commercially available examples are the Yamaha EZ-TP Trumpet (https://www.yamaha.com/en/about/innovation/collection/detail/0052/) and the Morrison Digital Trumpet (http://www.digitaltrumpet.com.au/). A 2008 Cornell University student project describes an electronic trumpet at https://people.ece.cornell.edu/land/courses/ece4760/FinalProjects/s2008/twc22_bef23/twc22 bef23/index.html. U.S. Pat. No. 3,938,419 (De Rosa) discloses an ELECTRONIC MUSICAL INSTRUMENT. These designs mimic a trumpet in size and function, using attachments to an actual trumpet (Cornell and De Rosa), providing a plastic trumpet replica (Yamaha), or providing a stylized full-size replica of a trumpet (Morrison). A common requirement of prior art is to use a trumpet mouthpiece to control production of trumpet notes.

The Yamaha EZ-TP resembles a full-size trumpet complete with mouthpiece, valves, and bell. According to the web site description, “Players can sing or hum melodies into the mouthpiece.” The presence of breath sounds a note, and the humming frequency selects the interval of notes selected by the valves. The mouthpiece is required to play the Yamaha instrument.

The Morrison Digital Trumpet mimics the size and shape of a trumpet. In the Morrison device a mouthpiece is used to sound notes when a flow of air through the mouthpiece is detected. The mouthpiece is required to play the Morrison instrument.

The Cornell project modifies a standard trumpet by fitting it with optical sensors to detect valve positions and a microphone situated at the trumpet mouthpiece to detect the presence of air flowing through the mouthpiece to sound notes. The mouthpiece is required to play the Cornell instrument.

De Rosa modifies a standard trumpet by fitting it with relays to detect valve positions and a microphone situated at the trumpet mouthpiece to detect the presence of air flowing through the mouthpiece to sound notes. The mouthpiece is required to play the De Rosa instrument.

It would be desirable to have an electronic trumpet that is more compact than a trumpet and which may be played without a mouthpiece to sound the notes. Playing an electronic trumpet with this feature leaves the mouth free while playing the instrument, for example to sing along while playing notes. One can fondly imagine Louis Armstrong playing his own trumpet obbligato while singing, “What a Wonderful World.”

### BACKGROUND OF THE INVENTION

The trumpet is a popular and well-known instrument, which may be chosen by beginning players. However, sounds produced by a person learning the trumpet can be loud and disturbing. Beginning players must learn rudiments of valve positions, embouchure, and breath control before moving on to an advanced skill of playing softly. Practice sessions may be interrupted by family members wishing for silence so they may accomplish tasks requiring concentration such as studying, carrying on a conversation with other family members or talking on the phone. Practicing a trumpet may be best done in certain settings, for example in a well isolated room at home or a band practice room. Practicing a trumpet in other settings such as in an automobile or in a library are not as practical. It would be advantageous to have a method for practicing a trumpet in any setting without disturbing anyone.

Playing a trumpet requires two distinct physical skills. First, positions of the three valves are used to select notes. Because there are three valves, the choice of notes is 2 to the power of 3 or eight notes. Playing notes beyond the eight notes selectable by the valves requires a second skill, which is the ability to vibrate the lips, pressed to the mouthpiece, at various frequencies to select trumpet note intervals. Two methods to produce the required lip vibrations are (a) to produce an audible “buzz” sound while blowing air through the mouthpiece, and (b) to vary lip tension while blowing, with no buzz, causing the lips passively to vibrate due to the moving air, much like the vibration of a double-reed of an instrument such as the bassoon.

Beginning players may be asked to learn mouthpiece technique by causing the lips to vibrate into a mouthpiece before picking up a trumpet. It would be advantageous to separate skills such that valve positions could be learned before mastering correct mouthpiece embouchure and breath discipline. Learning valve positions by playing notes without a mouthpiece may allow a beginner to start learning to play a trumpet before having the physical skill to master embouchure and breath control required with a mouthpiece. Playing an electronic trumpet without requiring a mouthpiece offers a further advantage that it may be played without engaging the player's mouth, leaving it free for other purposes such as singing while simultaneously playing.

These and other advantages may be achieved by an electronic trumpet according to the present invention. Playing it without requiring a mouthpiece separates the skills of valve dexterity and breath/embouchure control. A beginning player may learn valve positions and produce music separately from the challenge of mastering skills required with a mouthpiece. Because it is electronic, it can have a volume control and offer various listening means, including headphones. Because it is electronic, it can sound like other instruments than a trumpet, and play rich chords as notes.

### SUMMARY OF THE INVENTION

An electronic trumpet emulating the valves of a trumpet. Electronic sensors detect valve positions, and pushbuttons serve the dual purposes of selecting a range of notes selectable by the valves and sounding the notes when activated. A microcontroller translates the valve and button states into MIDI messages suitable for connecting to a MIDI synthesizer or other MIDI device, or to an internal MIDI Synthesizer Integrated Circuit.

### BRIEF DESCRIPTION OF DRAWINGS

FIG. 1 depicts a diagram of a trumpet highlighting the portion of a trumpet emulated by the invention.

FIG. 2 depicts a pictorial view of an electronic trumpet constructed according to an embodiment.

FIG. 3 depicts a pictorial view of an electronic trumpet constructed according to another embodiment.

FIG. 4 is an exploded pictorial view depicting arrangement of valve assemblies.

FIG. 5 is an exploded pictorial view of the FIG. 2 embodiment.

FIG. 6 is an exploded pictorial view of the FIG. 3 embodiment.

FIG. 7 is a circuit diagram of the device of FIG. 2.

FIG. 8 is a circuit diagram of the device of FIG. 3.

FIG. 9 is a flowchart depicting a program flow used by the microcontroller.

### DETAILED DESCRIPTION OF THE INVENTION

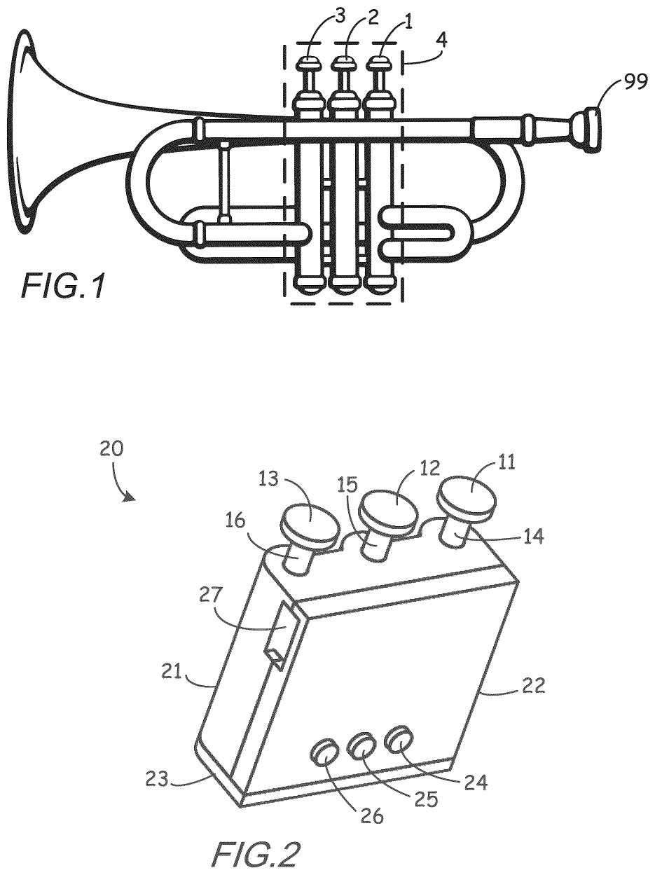

FIG. 1 is a diagram of a trumpet depicting the two trumpet components a player uses to produce trumpet notes. Finger buttons 1, 2 and 3 attach to internal valves to control the pitch of the note to be played. A player produces a vibratory excitation at mouthpiece 99 in order (a) to select a frequency range of notes selected by finger buttons 1, 2, 3, and (b) to regulate the presence or absence of a trumpet note sound according to the presence or absence of a flow of air into the mouthpiece. Accordingly, a trumpet player engages both fingers and mouth to play a trumpet, using a combination of finger dexterity, embouchure, and breath control. The enclosed area 4 is the portion of a trumpet emulated by the invention to help select notes to be played.

FIG. 2 is a diagram of an electronic trumpet 20 constructed according to an embodiment of the present invention. A portion of a trumpet 4 comprises three valves and a housing. Three caps 11,12,13 replicate the function of the three valve buttons 1,2,3, respectively, in FIG. 1. Stems 14,15,16 attach to the caps and connect to internal spring-loaded cylinders subsequently described. For simplicity, the assembly comprising caps, stems and cylinders are referred to as “valves.”

A housing comprises body 21, side cap 22 and end cap 23. The side and end caps may be attached to the body using common attachment means such as countersunk screws or internal latches. Opening 27 gives access to connectors mounted on an internal circuit board. Three pushbuttons 24,25,26 protrude from side cap 22 to serve the dual purposes of (a) determining the range of notes selected by depression of the valves, and (b) controlling the sounding of notes. Pressing one of the pushbuttons selects a range of notes selectable by the valves and sounds the selected note. Releasing all three buttons causes any sounding note to be silenced. In this manner an electronic trumpet may be played without a mouthpiece to determine which notes to play and when notes are heard. While an electronic trumpet 20 may contain three buttons, more than three buttons may be employed to increase the range of notes.

The housing may be 3D-printed using a 3D printer such as a Prusa i3Mk3 or similar, using a filament such as PLA (Polylactic Acid).

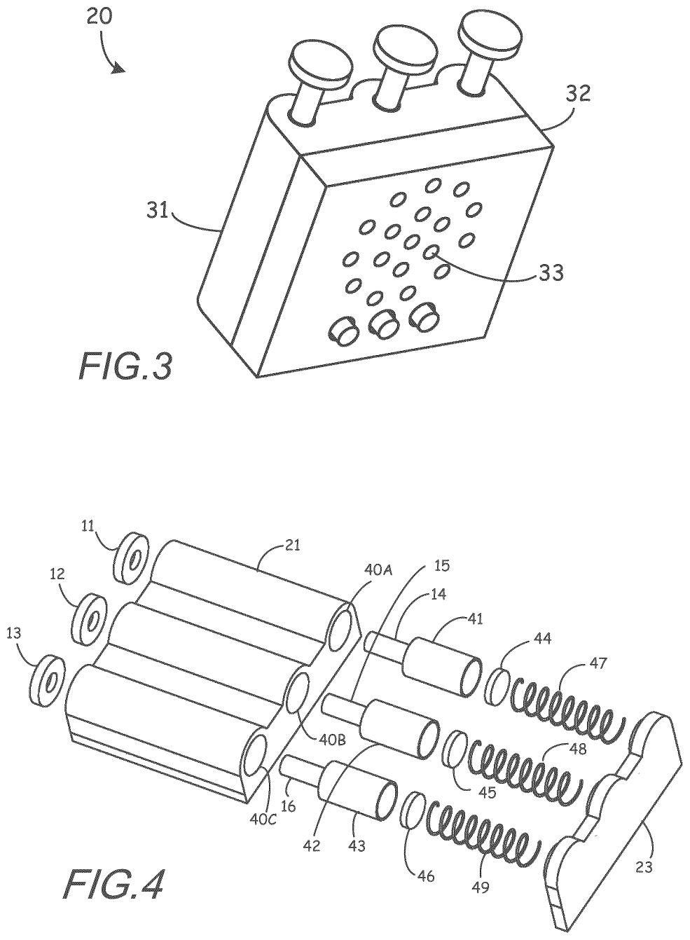

FIG. 3 is a diagram of an electronic trumpet 20 constructed according to another embodiment of the present invention which includes an internal speaker and a battery. As a self-contained embodiment, a connector opening such as 27 may not be required, side cap 32 may be thicker to accommodate an internal speaker, and an array of holes 33 may serve as a speaker grill.

FIG. 4. Is an exploded view depicting the arrangement of valve components inside body 21. Caps 11,12,13 and stems 14,15,16, respectively, are those of FIG. 2, separated to illustrate how they are assembled. The caps may be standard trumpet caps that mate with threaded holes on the tops of stems or they may be 3D printed and attached to the stems by press fit or glue. Chamber 40A accepts components 14,41,44 and 47, chamber 40B accepts components 15,42,45, and 48, and chamber 40C accepts components 16,43,46, and 49. Hollow cylinders 41,42 43 accept the stems at their tops by press-fit or glue. The hollow cylinders have an outer diameter slightly smaller than the inner diameter of the accepting chambers so they may move freely in the vertical direction but with little lateral motion (wobble) as with a trumpet. With 3D printed parts using PLA (Polylactic Acid) filament, a preferred clearance between the outer diameter of the cylinders and inner diameter of the accepting chambers is 0.2 millimeters.

The hollow cylinders 41,42,43 accept disc magnets 44,45 46 and springs 47,48,49, respectively. The disc magnets may be glued in place or captively held in place by compression of springs 57,58,59. Preferred magnets may be Neodymium magnets due to their strong magnetic fields in small sizes. A preferred magnet size may be 10 millimeters in diameter and 2 millimeters thick. The magnets are oriented near the top surfaces of the hollow cylinders, for example 5 millimeters below the top of a cylinder which may be 25 millimeters in length. The lineups of stems, hollow cylinders, disc magnets and springs are inserted into body 21 and held in place by end cap 23 which is attached to the body using common attachment means such as screws or latches. Springs 57,58,59 are chosen to give the same “feel” when valve caps are pressed as with a trumpet. After the internal assemblies are inserted and secured by the end cap, buttons 11,12,13 may be attached to the stems 14,15,16, respectively.

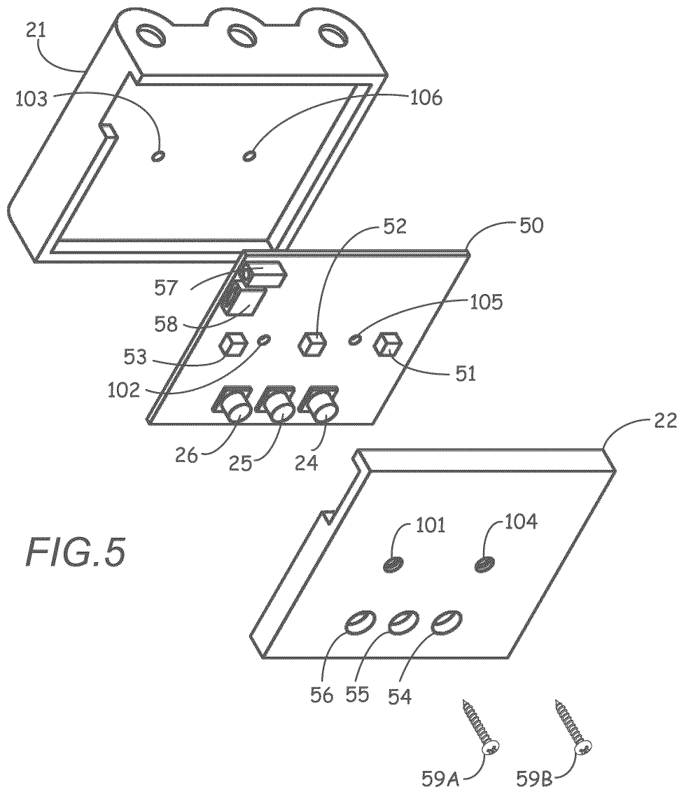

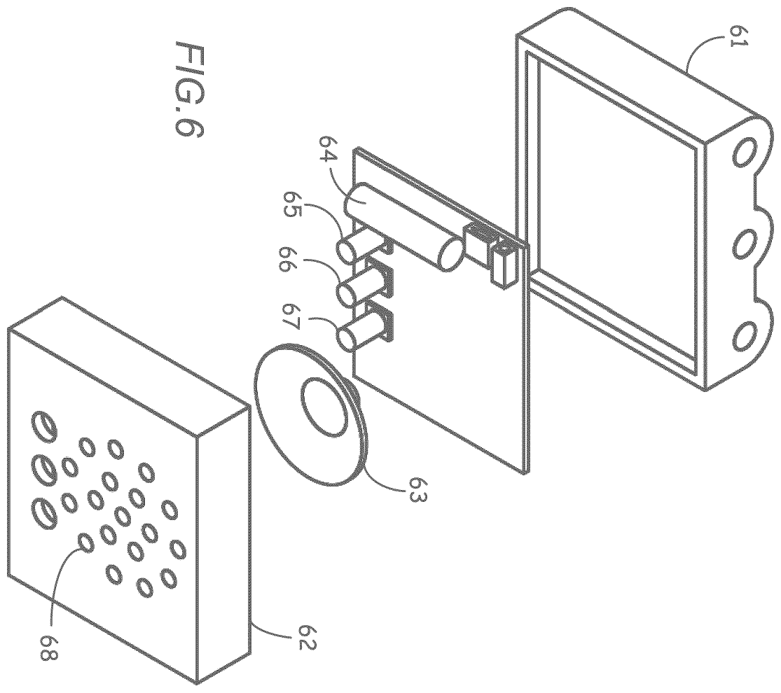

FIG. 5 is an exploded view of the present invention depicting body 21, a circuit board 50 and side cap 22. The circuit board contains electronic circuitry to operate the invention. Buttons 24,25,26 protrude through side cap openings 54,55,56, respectively. An assembly method inserts self-tapping screws into the side cap, passing through alignment holes in the circuit board, and into holes in the body. Screw 59A inserts into side cap hole 101, passes through circuit board hole 102, and secures to the body using hole 103. Screw 59B inserts into side cap hole 104, passes through circuit board hole 105, and secures to the body using hole 106. Connector 57 is a MIDI connector. An external cable connects between the MIDI connector and a MIDI synthesizer. MIDI synthesizers are plentiful (an Amazon search of “MIDI Synthesizer” returns over 16 million results) and they adhere to a published specification, available at www.midi.org. Connector 58 is a Universal Serial Bus (USB) receptacle serving two purposes. First, a USB connection to a development computer may facilitate microcontroller code development and checkout. Second, when the invention operates without attachment to a computer it may be powered over the USB connector using a smartphone charger or the like.

Three Hall-Effect switches 51,52,53 mount on the circuit board. The Hall-Effect switches detect the presence or absence of a magnetic field produced by disc magnets 44,45,46, respectively, in the valve assemblies. When circuit board 50 is mounted into body 21 each Hall-Effect switch aligns with a valve chamber, putting it in proximity to the disc magnet inside the valve. When a valve is depressed its internal disc magnet moves close enough to the Hall-Effect switch for it to switch ON. When a valve is released or is in the inactive position the internal magnet is far enough away from the Hall-Effect switch to switch it OFF. Hall-Effect sensors are available in various configurations including choice of sensitivities and packages. A typical Hall-Effect sensor is the A3144, available from Allegro Semiconductor and others. The A3144 is a Hall-Effect switch, providing an ON or OFF output signal indicating magnetic field presence or absence. Typical sensitivity for the A3144 is to switch its output ON in the presence of a magnetic field of 150-250 Gauss, and OFF when a magnetic field falls below 30-100 Gauss. The A3144 sensitivity range is suitable for the orientation of Hall-Effect switches and disc magnets in the invention.

Manipulation of a valve and its interaction with the Hall-Effect switches may be described using the valve controlled by key 11 as an example, which applies to all valves. When key 11 is not pressed, magnet 44 is far enough away from the Hall-Effect switch 51 that its output is OFF. When a player depresses cap 11, compressing spring 47 and moving hollow cylinder 41 downward, the magnet 44 comes into proximity to Hall-Effect switch 51, causing it to turn ON.

FIG. 6 is an exploded view of an alternative embodiment of the present invention depicting body 61, side cap 62, a loudspeaker 63, a battery 64 and three buttons 65,66,67. Because it is a self-contained embodiment, body 61 and the side cap may not require cutout 27 (FIG. 2) to allow access to internal connections. The side cap may be thicker compared to side cap 22 in FIG. 2 to accommodate the internal speaker and battery, and buttons 65,66,67 are taller than buttons 24,25,26, respectively, allowing them to protrude through the thicker side cap. This embodiment provides a compact and portable electronic trumpet.

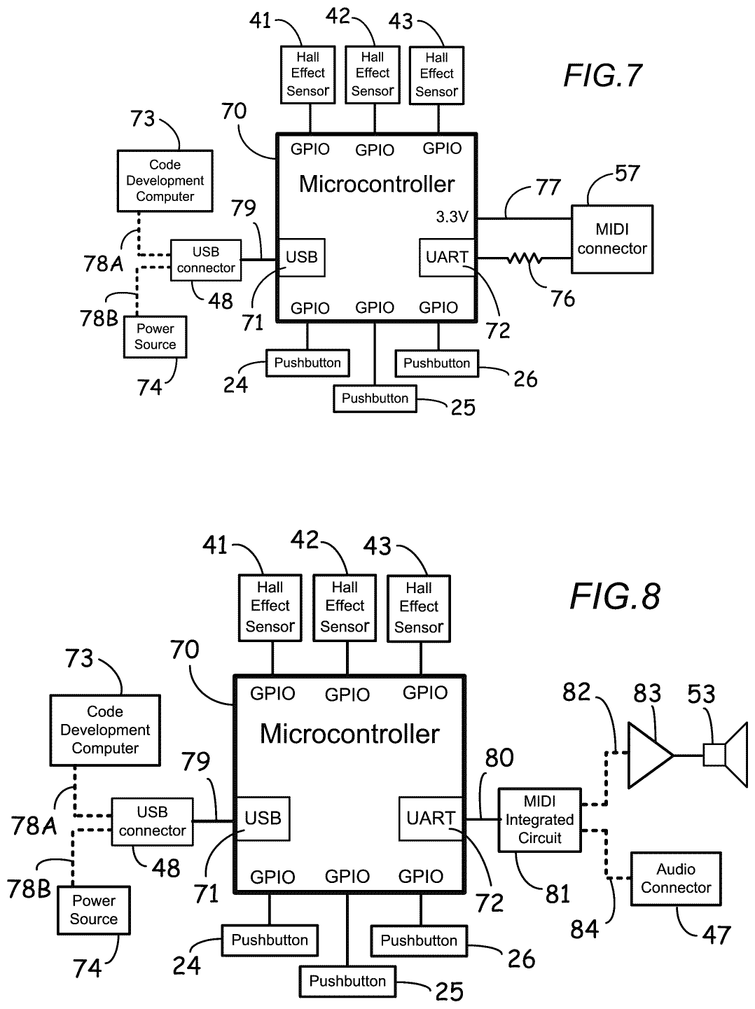

FIG. 7 is a block diagram of a microcontroller 70 mounted on circuit board 50. Microcontrollers are integrated circuits available from multiple vendors, including the RP2040 designed and sold by the Raspberry Pi Foundation (raspberrypi.com.) The RP2040 is offered as a low-cost module called the Pico which incorporates circuitry to operate the RP2040 such as a voltage regulator, a USB port, and access to GPIO (General-Purpose Input Output) pins. The Pico and variants include means to attach it to a larger circuit board such as board 50. Microcontroller 70 may be a Raspberry Pi Pico.

USB port 71 may connect to a development computer 73 using cable 78A to supply power and to load and debug program code to implement the invention. The USB port alternately may connect to a power source 74 such as a battery or USB charger over wire 7B to supply power to the system.

Six GPIO pins connect to Hall-Effect switches 41,42,43 and pushbuttons 24,25,26. Universal Serial Receiver Transmitter (UART) 72 is the interface to a MIDI device such as a synthesizer via connector 57. The input to a MIDI device is a 5 milliampere current loop which powers a light-emitting diode (LED) in an opto-isolator. The current loop comprises a positive voltage source on wire 77 and a current limiting resistor 76 whose value is chosen to provide a minimum of 5 milliamps of current. With a 3.3V source a suitable value of resistor 76 may be 470 Ohms. To be compatible with the MIDI Specification a Microcontroller configures its UART to communicate at the rate of 31,250 baud.

FIG. 8 depicts alternative embodiments of the invention replacing MIDI connector 75 and connections 76,77 with MIDI Integrated Circuit 81 and UART connection 80. A first alternative connection to the MIDI Integrated Circuit is connection 82, amplifier 83 and loudspeaker 63. A second alternative connection may be to provide an audio output from the MIDI Integrated Circuit via connection 84 and audio connector 47. In a self-contained embodiment, power source 74 may be an internal battery.

Integrated circuits implementing a MIDI instrument synthesizer are available. The VS1053 MIDI AUDIO CODEC CIRCUIT, available from www.vlsi.fi, contains 127 different instruments and 61 drum sounds. The SAM2695 LOW POWER SINGLE CHIP SYNTHESIZER WITH EFFECTS AND BUILT-IN CODEC, available from www.dream.fr, contains at least 127 different instruments and at least 61 drum sounds. These integrated circuits contain a “TTL-level” MIDI interface so current loop 76,77 of FIG. 7 may be replaced by connection 80 to UART 72.

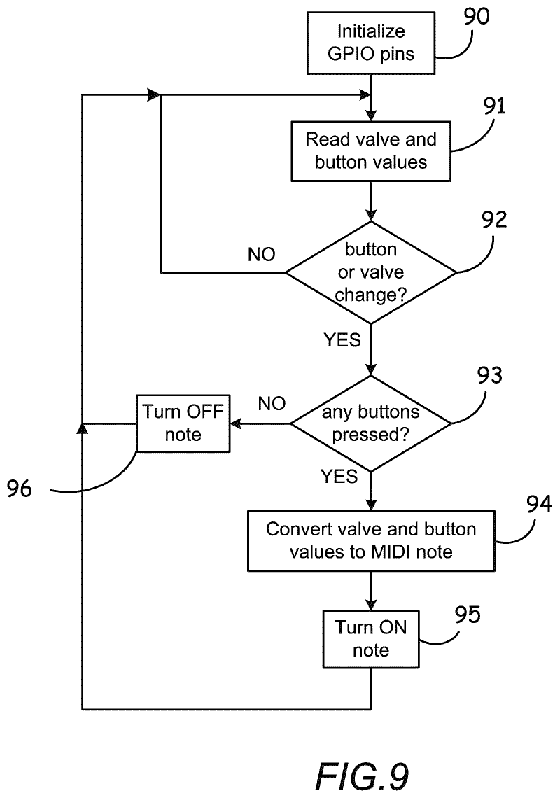

FIG. 9 is a flowchart of a program that may be executed by microcontroller 70. The term “valve” is used to indicate the state of a Hall-Effect switch 41,42 or 43, and the term “button” is used to indicate a button 24,25 or 26. When first powered, the microcontroller enters block 90 to initialize its General Purpose IO (GPIO) pins to serve as inputs and outputs. Six input pins are set to be inputs with pullup resistors to accommodate the three Hall-Effect switches and three pushbuttons. Pullup resistors are an internal microcontroller feature used to prevent floating inputs in the absence of an external signal being applied such as an open pushbutton. An output pin is programmed to be a UART output to drive the MIDI serial interface at 31,250 baud.

Program flow proceeds to block 91, where states of the valves and buttons are read. At decision block 92 a test is performed to determine if any of the valves or buttons have changed state since the last time they were read. If not, control reverts to block 91, where the inputs are again read. Loop 91-92 ensures that no MIDI messages are sent if the combination of valves and button states did not change.

If a change is detected in block 92, control passes to block 93 where the button states are checked. If none of the buttons are pressed, block 96 turns off the currently playing note and control passes back to the 91-92 loop to continue checking for new valve or button changes.

If a button is pressed, block 94 translates the combination of valve and button states into a MIDI note number and block 95 transmits a “Note ON” message containing the selected note to the UART. Control then passes back to the 91-92 loop to check for valve or button changes.

Decision block 93 implements the feature that a note is sounded when a button is pressed, and the note is silenced when all buttons are released. Because both valve and button states are checked for changes in blocks 91-92, an electronic trumpet player may change notes either with a button change or a valve change. This can create a “staccato” effect (playing short notes with pauses between them) by maintaining a valve position and tapping a button, or a “legato” effect (gliding between notes without pauses between them) by maintaining a button press and changing valve states.

The MIDI specification describes how messages are sent using a serial protocol, and it assigns numerical values to notes of the scale. Note frequencies are consecutively numbered chromatically with middle C on a piano keyboard having a reference value of 60 and the 88 piano keys ranging from 24 to 108.

The conversion of Hall-Effect switch states and button states to MIDI notes in block 84 may be done according to Table 1.

TABLE 1

| | Hall Switch | | | | | MIDI |
|---|---|---|---|---|---|---|
| Button | 24 | 25 | 26 | Index | Scale | note |
| 26 | 0 | 0 | 0 | 0 | C5 | 72 |
| | 0 | 1 | 0 | 2 | B | 71 |
| | 1 | 0 | 0 | 4 | Bb | 70 |
| | 1 | 1 | 0 | 6 | A | 69 |
| | 0 | 1 | 1 | 3 | Ab | 68 |
| | 0 | 0 | 1 | 1 | Ab | 68 |
| | 1 | 0 | 1 | 5 | G | 67 |
| | 1 | 1 | 1 | 7 | X | 20 |
| 25 | 0 | 0 | 0 | 0 | G | 67 |
| | 0 | 1 | 0 | 2 | F# | 66 |
| | 1 | 0 | 0 | 4 | F | 65 |
| | 1 | 1 | 0 | 6 | E | 64 |
| | 0 | 0 | 1 | 1 | E | 64 |
| | 0 | 1 | 1 | 3 | Eb | 63 |
| | 1 | 0 | 1 | 5 | D | 62 |
| | 1 | 1 | 1 | 7 | C# | 61 |
| 24 | 0 | 0 | 0 | 0 | C | 60 |
| | 0 | 1 | 0 | 2 | B | 59 |
| | 1 | 0 | 0 | 4 | Bb | 58 |
| | 1 | 1 | 0 | 6 | A | 57 |
| | 0 | 0 | 1 | 1 | A | 57 |
| | 0 | 1 | 1 | 3 | Ab | 56 |
| | 1 | 0 | 1 | 5 | G | 55 |
| | 1 | 1 | 1 | 7 | F# | 54 |

Table 1 indicates buttons 24,25,26, Hall-Effect switches 24,25,26, a decimal index representing the Hall-Effect switch states considering the Hall-Effect switch states as a 3-bit binary number, the notes of a scale represented by the button and Hall-Effect switch states, and a MIDI note range from 54 to 72, each note corresponding to a particular combination of Hall-Effect switch and button states. Increasing the number of buttons may provide a wider range of notes. A “1” in the Hall Switch columns indicates a valve is depressed and a “0” indicates it is not depressed. The Button column indicates which button is pressed to select the indicated note range. If button 24 is pressed the notes chosen by the three Hall-Effect switch states are MIDI notes 54-60. If button 25 is pressed the notes chosen by the three Hall-Effect switch states are MIDI notes 61-67. If button 26 is pressed the notes chosen by the three Hall-Effect switch states are MIDI notes 67-72. Certain trumpet notes may be played using more than one valve combination. For button 24 MIDI note 57 (the note A) can have Hall-Effect switch states 110 or 001; for button 25 MIDI note 64 (the note E) can have Hall-Effect switch states 110 or 001; and for button 26 MIDI note 68 (the note A-flat) can have Hall-Effect switch states 011 or 001. An additional duplication is MIDI note 67 (G) which may be played as button 25 using Hall-Effect switch state 000 or button 26 using Hall-Effect switch state 101. Of the notes selectable by button 26, Hall-Effect switch combination 111 does not produce a valid note on a trumpet, so this entry is shown as the MIDI note 20, which is a low frequency note used audibly to indicate to the player an invalid button/valve combination.

Table 1 may be reordered to represent the index values in numerical order from 0-7 for each button as seen in Table 2. This makes a MIDI note calculation amenable to a two-dimensional array representation with an outer index representing the button number and an inner index representing the index values 0-7.

TABLE 2

| button 24 | | button 25 | | button 26 | |
|---|---|---|---|---|---|
| Index | Note | Index | Note | Index | Note |
| 0 | 60 | 0 | 67 | 0 | 72 |
| 1 | 57 | 1 | 64 | 1 | 68 |
| 2 | 59 | 2 | 66 | 2 | 71 |
| 3 | 56 | 3 | 63 | 3 | 68 |
| 4 | 58 | 4 | 65 | 4 | 70 |
| 5 | 55 | 5 | 62 | 5 | 67 |
| 6 | 57 | 6 | 64 | 6 | 69 |
| 7 | 54 | 7 | 61 | 7 | 20 |

The advantages of the present invention include, without limitation, an electronic trumpet that is playable without a mouthpiece. The invention duplicates the valve portion of a trumpet, making it more compact than a trumpet. In place of a mouthpiece to require the flow of air to sound a note, the invention uses pushbuttons both to select a range of notes selectable by the valves and to turn notes on and off. Because the invention produces a MIDI compatible output, it is attachable to MIDI synthesizers, giving the advantage over a trumpet that while played like a trumpet it can sound like any instrument a MIDI synthesizer can reproduce. Leaving the mouth free while playing gives the advantage of allowing a player to sing along or speak while playing the electronic trumpet.

1. An apparatus comprising:
an enclosure containing valves that emulate the valve portion of a trumpet;
a circuit board in the enclosure containing a microcontroller using a microcontroller program;
the microcontroller attached to valve sensors and at least three buttons;
the valve sensors indicating to the microcontroller program the valve positions as depressed or released;
the buttons indicating to the microcontroller program the button states ON when depressed and OFF when not pressed;
the microcontroller program using valve positions to determine a selectable note in a certain range of notes;
the microcontroller program using button states first to determine the range of notes selectable by the valve positions and second to sound a selected note when a button is in the ON state, and to silence the note when all buttons are in the OFF state.

2. The apparatus of claim 1 wherein the microcontroller program uses valve positions and button states to compute a note number as defined by the Musical Instrument Digital Interface (MIDI) specification.

3. The apparatus of claim 1, further including a USB receptacle connected to the microcontroller.

4. The apparatus of claim 3, wherein the USB receptacle supplies power to the microcontroller.

5. The apparatus of claim 3, wherein the USB receptacle provides a connection to a computer.

6. The apparatus of claim 2, further including a MIDI synthesizer Integrated Circuit whose input is connected to a microcontroller output.

7. The apparatus of claim 6, further including a connector attached to the output of the MIDI synthesizer Integrated Circuit.

8. The apparatus of claim 6, further including an audio amplifier and a loudspeaker, wherein the output of the MIDI synthesizer Integrated Circuit is connected to the input of the audio amplifier and the speaker is connected to the output of the audio amplifier.

9. The apparatus of claim 1 wherein the valve sensors are Hall-Effect sensors responsive to magnets inside the valves.

10. A method of playing an electronic trumpet comprising trumpet valves and added buttons, wherein the player depresses the trumpet valves to select notes while simultaneously employing buttons for the dual purpose of first selecting the range of notes selected by the valves, and second controlling the sounding of notes or silence.
